(19) United States
(12) Patent Application Publication
(10) Pub. No.: US 2011/0105276 A1
(43) Pub. Date: May 5, 2011

(54) TRANSMISSION OVERDRIVE PROTECTION SYSTEM

(76) Inventor: Timothy M. Czerkies, Boyne Falls, MI (US)

(21) Appl. No.: 12/611,954

(22) Filed: Nov. 4, 2009

(51) Int. Cl. B60W 10/10

(52) U.S. Cl. 477/115

(57) ABSTRACT

A transmission overdrive protection system that includes a vehicle transmission control module linked with a vehicle transmission. A vehicle towing harness is coupled to the vehicle for connection to a trailer. An overdrive module is connected to the vehicle transmission control module and vehicle towing harness. The overdrive module includes a circuit board with a circuit providing a signal to the vehicle transmission control module that a trailer is attached to the vehicle automatically preventing an overdrive gear from being utilized in the transmission.

### FIELD OF THE INVENTION

The present invention relates to modules and with more particularity to modules to detect when a trailer is being towed by a vehicle and signal a vehicle controller to not allow the overdrive setting in the vehicle transmission to be used.

### BACKGROUND OF THE INVENTION

Many vehicles may have an overdrive gear within the transmission to improve fuel economy. Vehicles including the overdrive gear in the transmission may tow trailers with loads. When a load is being towed and the transmission is in an overdrive gear the transmission may fail requiring costly repairs. Vehicle transmissions are generally designed to accommodate trailer towing loads in gears other than the overdrive gear.

There is therefore a need in the art to prevent the vehicle transmission from shifting into overdrive gear when towing a load.

Many times, a vehicle operator may not disable the overdrive gear in the vehicle such that deterioration of the overdrive gear in the transmission results. There is also a need in the art for an apparatus that automatically disables an overdrive gear and does not require a vehicle operator to manually disengage an overdrive setting.

### SUMMARY OF THE INVENTION

In one aspect there is disclosed a transmission overdrive protection system that includes a vehicle transmission control module linked with a vehicle transmission. A vehicle towing harness is coupled to the vehicle for connection to a trailer. An overdrive module is connected to the vehicle transmission control module and vehicle towing harness. The overdrive module includes a circuit board with a circuit providing a signal to the vehicle transmission control module that a trailer is attached to the vehicle automatically preventing an overdrive gear from being utilized in the transmission.

In another aspect there is disclosed a transmission overdrive protection system that includes a vehicle transmission control module linked with a vehicle transmission. A vehicle towing harness is coupled to the vehicle for connection to a trailer. An overdrive module is connected to the vehicle transmission control module and vehicle towing harness. The overdrive module includes a housing having a circuit board disposed therein. A sealed connector is linked with wires connected to the circuit board. The overdrive module includes a circuit board with a circuit providing a signal to the vehicle transmission control module that a trailer is attached to the vehicle automatically preventing an overdrive gear from being utilized in the transmission.

In a further aspect there is disclosed a transmission overdrive protection system that includes a vehicle transmission control module linked with a vehicle transmission. A vehicle towing harness is coupled to the vehicle for connection to a trailer. An overdrive module is connected to the vehicle transmission control module and vehicle towing harness. A switching device is connected to the vehicle towing harness. The overdrive module includes a circuit board with a circuit providing a signal to the vehicle transmission control module that a trailer is attached to the vehicle automatically preventing an overdrive gear from being utilized in the transmission.

### BRIEF DESCRIPTION OF THE DRAWINGS

FIG. 1A is a schematic view of one embodiment of a transmission overdrive protection system;

FIG. 1B is a schematic view of one embodiment of a transmission overdrive protection system;

FIG. 2 is a perspective view of one embodiment of a module of a transmission overdrive protection system;

FIG. 3 is an exploded perspective view of one embodiment of a module of a transmission overdrive protection system;

FIG. 4 is a sectional view of one embodiment of a module of a transmission overdrive protection system;

FIG. 5 is a perspective view of one embodiment of a module of a transmission overdrive protection system showing a connector protruding through the housing wall;

FIG. 6 is an exploded perspective view of one embodiment of a module of a transmission overdrive protection system showing a connector protruding through the housing wall.

### DETAILED DESCRIPTION OF THE PREFERRED EMBODIMENTS

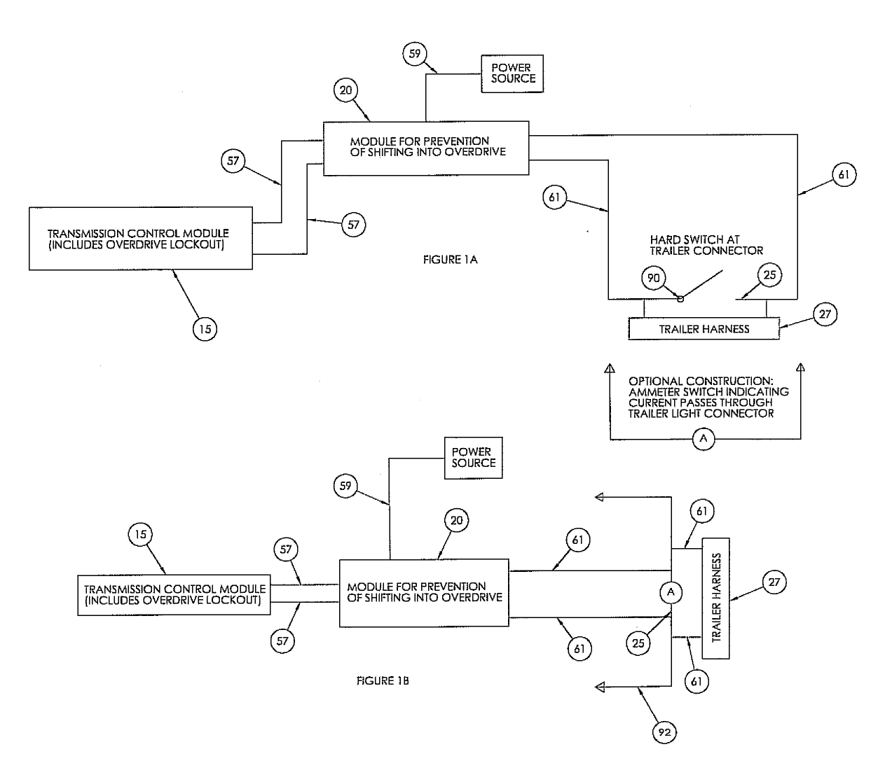

Referring to FIGS. 1A, B, there is shown embodiments of a transmission overdrive protection system 10. The system 10 may include a transmission control module 15 in communication with an overdrive module 20. The overdrive module 20 may be linked with a switching device 25 associated with a towed trailer. The switching device 25 may be connected to a vehicle towing harness 27. The switching device 25 may have various structures and will be discussed in more detail below.

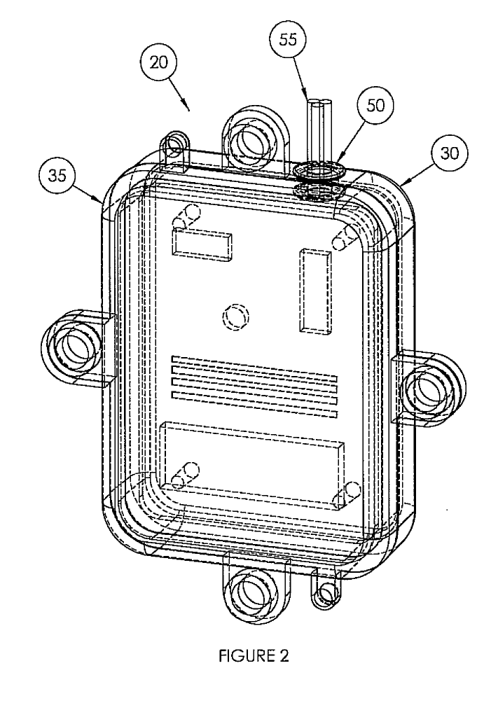

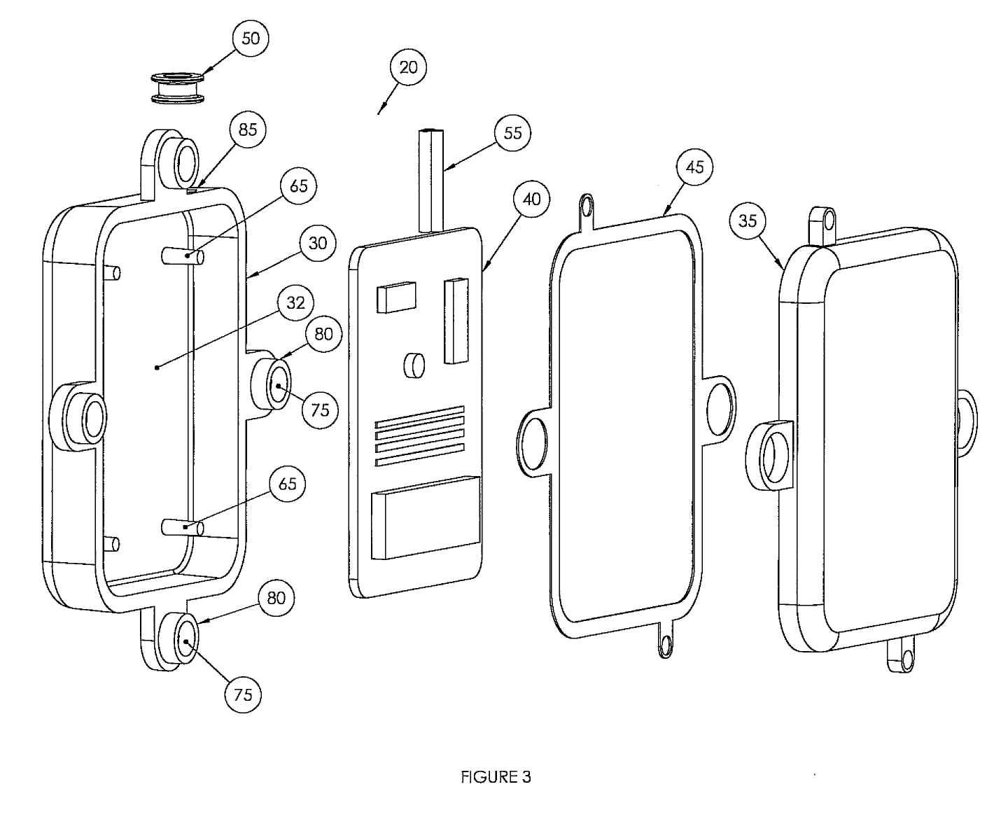

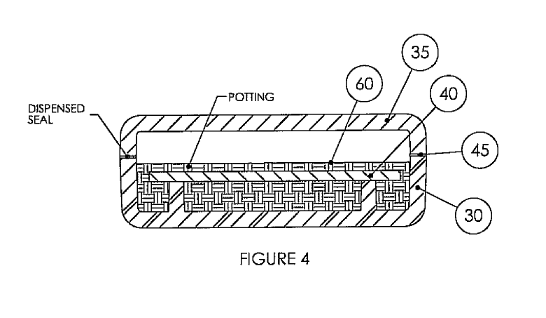

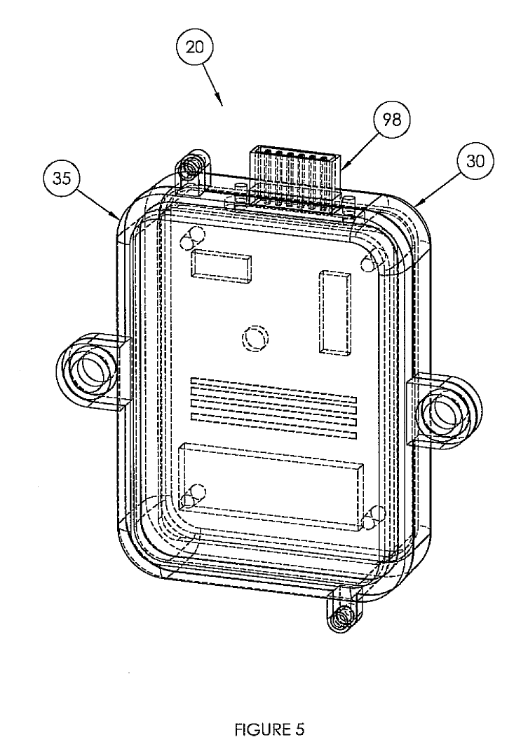

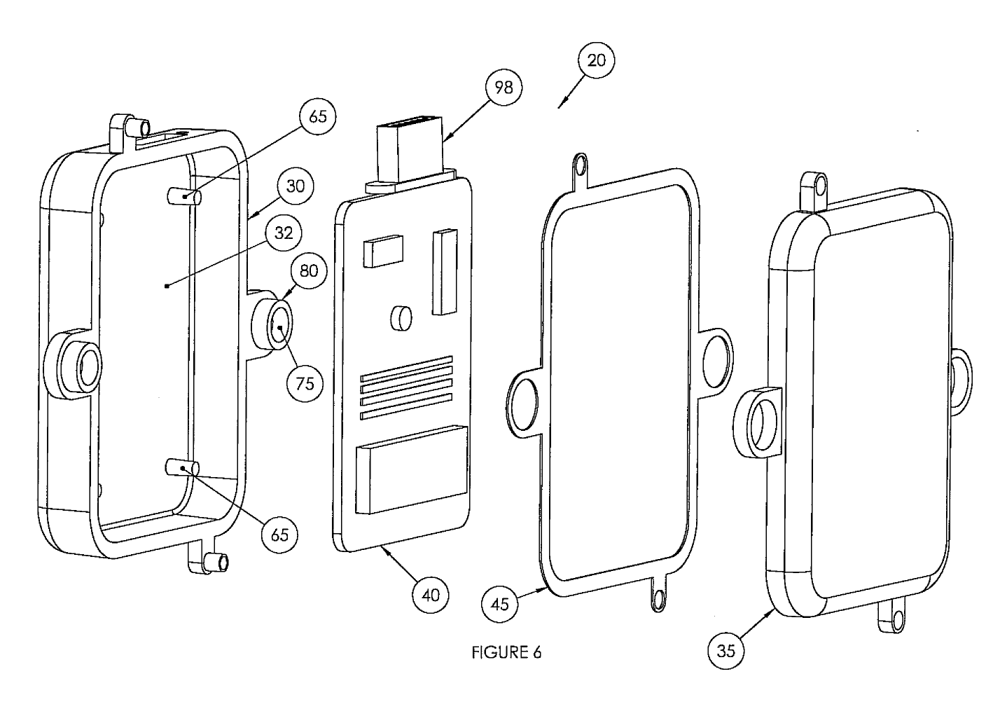

Referring to FIG. 2-6, the overdrive module 20 may include a housing 30, a cover 35, a circuit board 40, a gasket 45, a wire harness seal or grommet 50 and wires 55. In one aspect, the housing 30 may be filled with a potting material 60 after the circuit board 40 has been installed to provide corrosion and vibration protection. The housing 30 can be plastic or metal with a cavity 32 to enclose and support the circuit board 40. In one aspect, the housing 30 may be an injection molded plastic component to save weight and reduce cost. Those skilled in the art recognize that the housing 30 can be manufactured from a variety of materials and using a variety of methods.

The housing 30 may include a cavity 32 with integral supports 65 for the circuit board 40. The housing 30 may also include a top sealing surface 70. The housing 30 may also include mounting holes 75 for securing the overdrive module 20 to a surface or other attachment structure on the vehicle. Crush limiters 80 may be installed in the housing 30 around the mounting holes 75. The crush limiters 80 may be insert molded or inserted into the housing 30 after molding of the housing 30. The crush limiters 80 allow mounting fasteners for the overdrive module 20 to clamp on the crush limiters 80 when the overdrive module 20 is installed. In one aspect, the crush limiters 80 may protrude from the housing 30 to locate the cover 35 for installation. In one aspect, crush limiters 80 are included in the housing 30 to prevent plastic material creep when the housing is attached to the surface with some type of fasteners. Those skilled in the art recognize that a variety of fastening methods could be used to attach the housing to the mounting surface, including, but not limited to threaded fasteners, push in type fasteners, or integral molded plastic clips.

As stated above, the housing 30 may include a top surface 70 to allow the housing 30 to be sealed when the cover 35 is installed preventing intrusion of water and other contaminants. In one aspect, a gasket 45 may be positioned between the housing 30 and the cover 35 such that it is compressed when installed to provide a seal against contaminants. In another aspect, the gasket 45 may be positioned between the housing 30 and cover 35 and be a dispensed seal that both seals and fastens the cover 35 to the housing 30. For example, silicone adhesives and other sealing adhesives may be utilized.

The housing 30 may also include a bore 85 formed through one surface defining a wire exit and entrance. The bore 85 may be sealed with a grommet 50 to eliminate water ingress around the wires 55. In one aspect, a plurality of wires 55 may be connected to the overdrive module 20. In the depicted embodiment, two signal wires 57 may exit the overdrive module 20 to prevent shifting into overdrive when a trailer load is being towed. The signals wires may be routed and connected to the vehicle transmission control module 15 to indicate that a trailer is attached to the vehicle and the overdrive gear should not be used. Additionally, a wire 59 carrying electrical power may be included to provide power to a test circuit on the circuit board 40. Further, in the depicted embodiment, two wires 61 may exit the overdrive module 20 and connect to a vehicle towing harness 27. The wires 61 may be utilized to test if a trailer is being towed by the vehicle. In one aspect, a switch 90 best seen in FIG. 1A may be coupled with a vehicle towing harness 27 to indicate if a trailer is connected to the vehicle. In another aspect as shown in FIG. 1B, an ammeter switch 92 may be coupled with a vehicle towing harness 27 indicating when current passes through a trailer light connector.

The circuit board 40 may be secured inside the housing 30 and performs the functions of testing to see if the trailer lighting connector is plugged into the vehicle towing harness 27 and also signal the vehicle transmission control module 15 to disable the overdrive gear in the transmission. The circuit board 40 may contain a variety of electrical and electronic components to accomplish these purposes and those skilled in the art recognize that a variety of designs of the circuit board 40 are available to accomplish the purpose. The circuit board 40 may be mounted in the housing 30. In one aspect, the circuit board 40 contains a test circuit to determine if the trailer lights are plugged in to the vehicle towing harness 27. The circuit board 40 sends a signal to determine if the trailer connector is inserted into the vehicle harness connector. A small current may be sent through one of the trailer light connector grounding circuit to check for a completed circuit. Those skilled in the art recognize that mechanical switches or many other options can be used to determine if the trailer light connector is inserted in the vehicle harness connector.

As stated above, the circuit board 40 may be surrounded in potting material 60 if the mechanical and environmental requirements necessitate the complete enclosure of the circuit board 40. The circuit board 40 may also include a coating of various materials and compositions to protect the circuit board 40.

In use, the circuit board 40 may be installed in the housing 30 with the appropriate wires 55 attached to the circuit board 40. The wires 55 may be connected to the circuit board 40 and to a connector 98. The connector 98 may be linked with the vehicle towing harness 27 and the transmission control module 15 as described above. As described above the housing 30 may be filled with potting material 60. The cover 35 may be placed on the top surface 70 of the housing 30 after the gasket 85 is installed. The wires 55 may enter and exit through the bore 85. A grommet 50 may be received in the bore 85 to seal the bore 85. The grommet 50 may be molded over the wires 55. Those skilled in the art recognize that many other designs may be utilized to seal and strain relieve the wire entrance and exit from the housing 30.

The overdrive module 70 may be attached to the vehicle using the mounting holes 75. The crush limiters 80 allow mounting fasteners for the overdrive module 20 to clamp on the crush limiters 80 when the overdrive module 20 is installed. The signals wires 57 connected to the circuit board 40 may be routed and connected to the vehicle transmission control module 15 to indicate that a trailer is attached to the vehicle and the overdrive gear should not be used. Additionally, the wire 59 carrying electrical power may be included to provide power to the test circuit on the circuit board 40. The wires 61 may be routed from the circuit board 40 to test if a trailer is being towed by the vehicle. In one aspect, a switch 90 best seen in FIG. 1A may be coupled with a vehicle towing harness 27 to indicate if a trailer is connected to the vehicle. In another aspect as shown in FIG. 1B, an ammeter switch 92 may be coupled with a vehicle towing harness 27 indicating when current passes through a trailer light connector. As stated above, the circuit board 40 also signals the vehicle transmission control module 15 that a trailer light connector is attached to the vehicle harness. In one aspect, conductors for the electrical signal to the vehicle transmission controller 15 exit the housing 30 and can be connected to the vehicle transmission control module 15 to process the signal. Those skilled in the art recognize a variety of designs are possible to signal the vehicle transmission control module that a trailer light connector is connected, including wireless transmitters.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A transmission overdrive protection system comprising:
a vehicle transmission control module linked with a vehicle transmission;
a vehicle towing harness coupled to the vehicle for connection to a trailer;
an overdrive module connected to the vehicle transmission control module and vehicle towing harness, the overdrive module including a circuit board with a circuit providing a signal to the vehicle transmission control module that a trailer is attached to the vehicle automatically preventing an overdrive gear from being utilized in the transmission.

2. The transmission overdrive protection system of claim 1, wherein the circuit board is disposed within a housing having a cover attached thereto.

3. The transmission overdrive protection system of claim 2, wherein the housing has one or more mounting holes for mounting the overdrive module to the vehicle.

4. The transmission overdrive protection system of claim 3, wherein the housing mounting holes include crush limiters preventing housing creep after attachment to the vehicle.

5. The transmission overdrive protection system of claim 4, wherein the crush limiters protrude from the housing locating the cover to the housing.

6. The transmission overdrive protection system of claim 2, wherein the cover is attached and sealed to the housing a dispensed adhesive product.

7. The transmission overdrive protection system of claim 2, wherein the cover is mechanically attached to the housing and including a gasket positioned between the housing and cover sealing the overdrive module.

8. The transmission overdrive protection system of claim 1 wherein the circuit board is coated protecting the circuit board.

9. The transmission overdrive protection system of claim 2, wherein the housing includes potting material disposed therein and surrounding the circuit board.

10. The transmission overdrive protection system of claim 1, including wires exiting the housing and linked with the circuit board, the wires disposed within a grommet for sealing.

11. The transmission overdrive protection system of claim 1, including a sealed connector protruding through the housing, the sealed connector linked with wires connected to the circuit board.

12. The transmission overdrive protection system of claim 1, including a switch coupled with the vehicle towing harness to indicate if a trailer is connected to the vehicle.

13. The transmission overdrive protection system of claim 1, including an ammeter switch coupled with the vehicle towing harness indicating when current passes through a trailer light connector.

14. A transmission overdrive protection system comprising:
a vehicle transmission control module linked with a vehicle transmission;
a vehicle towing harness coupled to the vehicle for connection to a trailer;
an overdrive module connected to the vehicle transmission control module and vehicle towing harness, the overdrive module including a housing having a circuit board disposed therein, and a sealed connector linked with wires connected to the circuit board, the circuit board having a circuit providing a signal to the vehicle transmission control module that a trailer is attached to the vehicle automatically preventing an overdrive gear from being utilized in the transmission.

15. The transmission overdrive protection system of claim 14, including a switch coupled with the vehicle towing harness to indicate if a trailer is connected to the vehicle.

16. The transmission overdrive protection system of claim 14, including an ammeter switch coupled with the vehicle towing harness indicating when current passes through a trailer light connector.

17. A transmission overdrive protection system comprising:
a vehicle transmission control module linked with a vehicle transmission;
a vehicle towing harness coupled to the vehicle for connection to a trailer;
an overdrive module connected to the vehicle transmission control module and vehicle towing harness;
a switching device connected to the vehicle towing harness;
the overdrive module including a circuit board with a circuit providing a signal to the vehicle transmission control module that a trailer is attached to the vehicle automatically preventing an overdrive gear from being utilized in the transmission.

18. The transmission overdrive protection system of claim 17, wherein the switching device includes a switch coupled with the vehicle towing harness to indicate if a trailer is connected to the vehicle.

19. The transmission overdrive protection system of claim 17, wherein the switching device includes an ammeter switch coupled with the vehicle towing harness indicating when current passes through a trailer light connector.
